(19) United States
(12) Patent Application Publication
(10) Pub. No.: US 2005/0008329 A1
(43) Pub. Date: Jan. 13, 2005

(54) Disc apparatus, controlling method thereof, and controlling program thereof

(76) Inventors: Takao Suzuki, Kanagawa (JP); Kenji Hyodo, Kanagawa (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/868,860

(22) Filed: Jun. 17, 2004

(30) Foreign Application Priority Data
Jun. 26, 2003 (JP) P2003-182546

(51) Int. Cl. H04N 5/93; G11B 27/00

(52) U.S. Cl. 386/52; 386/55

(57) ABSTRACT

Main AV data having a high resolution and sub AV data are recorded on a disc. The sub AV data has been compression-encoded in accordance with the main AV data at a higher compression rate than the main AV data. When it has been determined that since a buffer underflow takes place in a seek from a designated OUT point to a designated IN point of the sub AV data and it cannot be reproduced in real time in accordance with an edit result of AV data recorded on the disc, a bridge clip is created so that the seek time becomes short. At that point, a reproduction range of the main AV data corresponding to the sub AV data is compression-encoded in accordance with a compression-encoding system of the sub AV data. As a result, a bridge clip for sub AV data is created.

### BACKGROUND OF THE INVENTION

1. Field of the Invention

The present invention relates to a disc apparatus, a controlling method thereof, a controlling program thereof that allow data recorded on a disc shaped recording medium to be edited.

2. Description of the Related Art

In recent years, disc shaped recording mediums such as a compact disc rewritable (CD-RW) disc and a digital versatile disc-rewritable (DVD-RW) disc that are capable of repeatedly writing and erasing data and a compact disc-recordable (CD-R) disc and a digital versatile disc-recordable (DVD-R) disc that are capable of recording data have been increasingly used as their prices have been gradually reduced. In addition, disc shaped recording mediums that use a laser having a short wavelength as a light source have come out as mediums that are capable of recording and reproducing a large capacity of data. For example, with a light source of a blue-purple laser that irradiates laser light having a wavelength of 405 nm and a single-sided single-layer optical disc, a recording capacity of 23 GB (Gigabytes) has been accomplished.

On these disc shaped recording mediums, predetermined data can be randomly accessed. When audio video (AV) data such as video data and audio data is repeatedly written and erased, AV data to be successively reproduced may be recorded in separate areas.

Such separation of AV data on a disc shaped recording medium may occur when a nondestructive editing operation is performed for the AV data. The nondestructive editing operation is an editing method of which so-called edit points such as IN points and OUT points are designated for AV data as material data recorded on a disc shaped recording medium, but material data itself is not edited. The nondestructive editing is derived from the fact that material data is not destroyed. In the nondestructive editing operation, a list of edit points that have been designated in an editing operation is created. The list is referred to as edit list. When the edit result is reproduced, material data recorded on the disc shaped recording medium is reproduced in accordance with edit points described in the edit list.

When a reproducing apparatus reproduces AV data that has been recorded in separate areas of a disc shaped recording medium by the nondestructive editing operation, since it should reproduce the separate areas, a seek takes place from one separate area to another separate area. If the time period for the seek is large, since AV data cannot be reproduced by the reproduction time, the reproduction of the AV data is stopped. Thus, the AV data may not be reproduced in real time.

A technology for reallocating separately recorded material data as reallocated data on a disc shaped recording medium is described in Patent Related Art Reference 1. As a result, a buffer under-run that results from a large seek time can be prevented. Consequently, when AV data that has been nondestructively edited is reproduced, it can be securely reproduced in real time.

[Patent Related Art Reference 1]

Japanese Patent Laid-Open Publication No. 2002-158974

For a video camera and so forth, a technology for generating a high resolution main video signal (referred to as main AV data) and a low resolution video data (referred to as sub AV data) corresponding to a photographing signal photographed by a video camera has been proposed. The sub AV data is suitable for example when a video signal should be quickly transmitted through a network or when a shuttle operation for searching a video picture by a fast forward operation or a rewind operation is performed. The sub AV data is generated by compression-encoding main AV data in accordance with a compression-encoding system having a higher compression rate than the main AV data.

Now, it is assumed that the foregoing nondestructive editing operation is performed in a system that generates sub AV data in accordance with main AV data. In this case, the nondestructive editing operation is performed for the main AV data and an edit limit is created. In addition, the nondestructive editing operation is performed for sub AV data. Since record positions of the main AV data and the sub AV data are different on a disc shaped recording medium, data separate states of them may differ on the medium. As a result, reallocated data of main AV data and reallocated data of sub AV data may differ on the medium.

Since main AV data is edited in the unit of one frame, sub AV data is automatically edited in the unit of one frame. As an edit result, an edit list is created. The sub AV data is compression-encoded at a high compression rate using intra-frame compression and inter-frame compression of a compression-encoding system for example the MPEG2 (Moving Pictures Experts Group 2) system or the MPEG4 system. The compression-encoding system used in the MPEG2 system and the MPEG4 system is an irreversible compression-encoding system of which after data is encoded, the original data cannot be completely restored.

The inter-frame compression is performed by a predictive encoding operation in accordance with a moving vector. The inter-frame compression uses an I picture that is completed as an image with one frame, a P picture that references a chronologically preceded frame or a chronologically followed frame, and a B picture that references both a chronologically preceded frame and a chronologically followed frame. A group composed of a plurality of frames that contain an I picture as a reference picture, a P picture, and a B picture is referred to as group of picture (GOP). As mentioned above, a P picture and a B picture themselves cannot be used as frame images. Thus, when reallocated data is created with an edit point other than a boundary of a GOP, it is necessary to temporarily decode data that has been inter-frame compressed, restructure frames, create a bridge clip with the restructured frames, and then perform the inter-frame compression for the resultant data.

Main AV data may be inter-frame compressed. In this case, the main AV data that has been inter-frame compressed is temporarily decoded and then frames are restored. As a result, the editing operation can be performed in the unit of one frame.

Sub AV data has been compression-encoded at a high compression rate by an irreversible compression-encoding system. The picture quality of sub AV data is inferior to that of main AV data. As described above, when sub AV data is reallocated, the sub AV data is temporarily decoded and then compression-encoded at a high compression rate. Thus, the picture quality of the sub AV data remarkably deteriorates.

### OBJECTS AND SUMMARY OF THE INVENTION

Therefore, an object of the present invention is to provide a disc apparatus, a controlling method thereof, and a controlling program thereof that allow deterioration of reallocated data of second data of which first data has been compression-encoded at a high compression rate to be suppressed.

To solve the foregoing problem, a first aspect of the present invention is a picture processing apparatus, comprising reproducing means for reproducing first data recorded on a recording medium and/or second data encoded at a higher compression rate than the first data; determining means for determining whether or not the second data can be reproduced by the reproducing means in real time in accordance with an edit list that represents a reproduction order of the first data and/or the second data; and generating means for generating real time reproduction data from the first data when the determined result represents that the second data can not be reproduced in real time.

A second aspect of the present invention is a picture processing method, comprising the steps of reproducing first data recorded on a recording medium and/or second data encoded at a higher compression rate than the first data; determining whether or not the second data can be reproduced at the reproducing step in real time in accordance with an edit list that represents a reproduction order of the first data and/or the second data; and generating real time reproduction data from the first data when the determined result represents that the second data can not be reproduced in real time.

A third aspect of the present invention is a picture processing program causing a computer device to execute a picture processing method, comprising the steps of reproducing first data recorded on a recording medium and/or second data encoded at a higher compression rate than the first data; determining whether or not the second data can be reproduced at the reproducing step in real time in accordance with an edit list that represents a reproduction order of the first data and/or the second data; and generating real time reproduction data from the first data when the determined result represents that the second data can not be reproduced in real time.

As described above, first data recorded on a recording medium and/or second data encoded at a higher compression rate than the first data are reproduced. It is determined whether or not the second data can be reproduced at the reproducing step in real time in accordance with an edit list that represents a reproduction order of the first data and/or the second data. Real time reproduction data is generated from the first data when the determined result represents that the second data can not be reproduced in real. Thus, real time reproduction data of the second data can be generated with higher quality than before and recorded on the recording medium.

These and other objects, features and advantages of the present invention will become more apparent in light of the following detailed description of a best mode embodiment thereof, as illustrated in the accompanying drawings.

### BRIEF DESCRIPTION OF THE DRAWINGS

The invention will become more fully understood from the following detailed description, taken in conjunction with the accompanying drawing, wherein like reference numerals denote like elements, in which:

FIG. 1 is a schematic diagram showing a data structure of a unique material identifier (UMID);

FIG. 2 is a schematic diagram showing an example of ring data formed on an optical disc;

FIG. 3A and FIG. 3B are schematic diagrams showing examples of which data is read from and written to an optical disc on which ring data has been formed;

FIG. 4A, FIG. 4B, and FIG. 4C are schematic diagrams describing that data is recorded so that continuity of rings is secured;

FIG. 5A, FIG. 5B, FIG. 5C, and FIG. 5D are schematic diagrams describing an allocation unit;

FIG. 6 is a schematic diagram describing a data management structure according to an embodiment of the present invention;

FIG. 7 is a schematic diagram describing a clip;

FIG. 8 is a schematic diagram describing a data management structure according to an embodiment of the present invention;

FIG. 9 is a schematic diagram describing a data management structure according to an embodiment of the present invention;

FIG. 10A, FIG. 10B, and FIG. 10C are conceptual schematic diagrams showing a bridge clip;

FIG. 11A, FIG. 11B, FIG. 11C, and FIG. 11D are schematic diagrams showing an example of a method for creating a bridge clip for sub AV data with the sub AV data itself;

FIG. 12A and FIG. 12B are schematic diagrams showing a method for creating a bridge clip for sub AV data with main AV data according to the present invention;

FIG. 13 is a block diagram showing an example of the structure of a disc recording and reproducing apparatus according to an embodiment of the present invention; and

FIG. 14 is a block diagram showing an example of the structure of a data converting portion.

### DETAILED DESCRIPTION OF THE PREFERRED EMBODIMENTS

Next, an embodiment of the present invention will be described. According to the present embodiment, first data having a high resolution and second data that has been compression-encoded at a high compression rate in accordance with the first data are recorded on a disc shaped recording medium. When the second data that has been nondestructively edited is reproduced, if a seek between edit points is later than a decoding operation of the second data, the second data cannot be reproduced in real time. At that point, the second data is reallocated on the disc and a bridge clip is created. At that point, since a bridge clip of the second data is created with the first data, the data quality of the bridge clip of the second data can be prevented from deteriorating.

In the following description, it is assumed that the first data is AV data that has been compression-encoded with a high resolution as an object to be actually broadcast or edited (the first data is referred to as main AV data) and that the second data is sub AV data corresponding to the main AV data.

A recording and reproducing apparatus according to the embodiment of the present invention is capable of recording and reproducing data to and from for example a single-sided single-layered optical disc that has a recording capacity of 23 GB (Gigabytes) using a light source of a blue-purple laser that irradiates laser light having a wavelength of 405 nm.

Main AV data is compression-encoded and recorded on the optical disc in accordance with for example the MPEG2 system so that the bit rate of video data of a base band satisfies 50 Mbps (Mega bits per second). According to the present embodiment, video data of the main AV data is composed of only I pictures so that the video data can be easily edited. In other words, in video data of the main AV data, one GPO is composed of one I picture.

Alternatively, the main AV data may be compression-encoded by inter-frame compression. In this case, when the main AV data is edited, the main AV data that has been compression-encoded is temporarily decoded. As a result, frames are restored. The frames are edited in the unit of one frame. Thereafter, the frames are compression-encoded by inter-frame compression. When the compression-encoding operation is performed at a low compression rate, a practical picture quality can be obtained.

Sub AV data is audio/video data corresponding to the main AV data. Sub AV data has a low bit rate. Sub AV data is generated by compression-encoding main AV data so that the bit rate thereof is decreased to several Mbps. As an encoding system that generates sub AV data, for example the MPEG4 system can be used. According to the present embodiment, the bit rate of sub AV data is fixed to several Mbps. One GOP of video data is composed of one I picture and nine P pictures.

Meta data is superordinate data of particular data. Meta data functions as an index of content of various types of data. Meta data is categorized as two types that are time sequence meta data that is generated along a time sequence of the foregoing main AV data and non-time sequence meta data such as scenes of main AV data that take place in predetermined regions.

In time sequence data, for example a time code, a UMID, and an essence mark are essential data. In addition, camera meta information such as an iris and zoom information of a video camera in a photographing state can be contained in time sequence meta data. Moreover, information prescribed in ARIB (Association of Radio Industries and Businesses) may be contained in time sequence meta data.

Non-time sequence meta data contains a time code, change point information of a UMID, information of an essence mark, a user bit, and so forth.

Next, a UMID will be described in brief. A UMID is an identifier that identifies video data, audio data, and other material data. A UMID is prescribed in SPTE-330M.

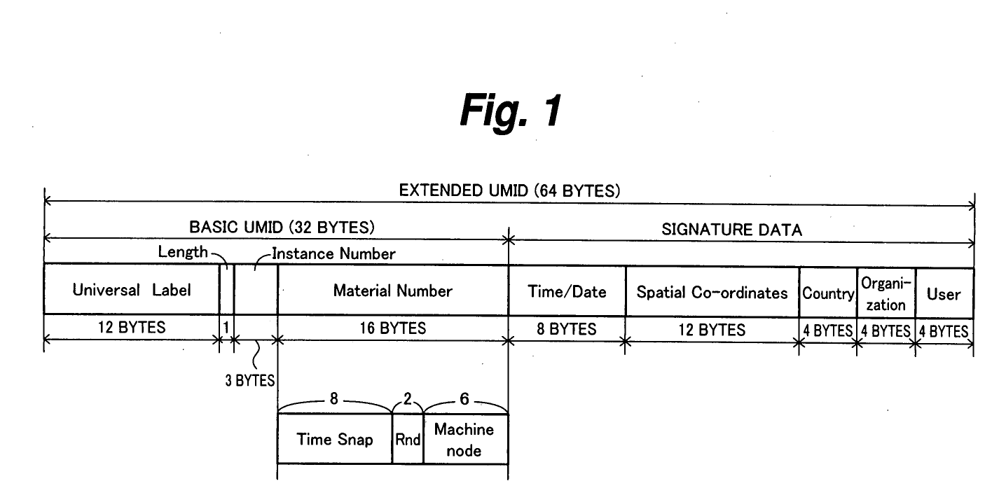

FIG. 1 shows a data structure of a UMID. A UMID is composed of a basic UMID as ID information that identifies material data and signature meta data that identifies each content of the material data. The basic UMID and the signature meta data each have a data area having a data length of 32 bytes. An area having a data length of 64 bytes of which the basic UMID and the signature meta data are added is referred to as extended UMID.

A basic UMID is composed of an area Universal Label having a data length of 12 bytes, an area Length Value having a data length of one byte, an area Instance Number having a data length of three bytes, and an area Material Number having a data length of 16 bytes.

The area Universal Label describes that it is immediately followed by the UMID. The area Length Value describes the length of the UMID. Since the code length of the basic UMID is different from the code length of the extended UMID, the area Length describes the basic UMID as a value [13h] and the extended UMID as a value [33h]. In the brackets, “h” followed by a numeral represents hexadecimal notation. The area Instance Number describes whether or not an overwrite process or an editing process has been performed for the material data.

The area Material Number is composed of three areas that are an area Time Snap having a data length of eight bytes, an area Rnd having a data length of two bytes, and an area Machine node having a data length of six bytes. The area Time Snap describes the number of snap clock samples per day. Created date and time of material data represented with clock samples. The area Rnd describes a random number that prevents numbers from overlapping when an inaccurate time is set or when a network address of a device that is defined in an IEEE standard is changed.

The signature meta data is composed of an area Time/Date having a data length of eight bytes, an area Spatial Co-ordinates having a data length of 12 bytes, an area Country having a data length of four bytes, an area Organization, and an area User.

The area Time/Date describes created time and date of a material. The area Spatial Co-ordinate describes compensation information (time difference information) of created time of a material and position information that is latitude, longitude, and altitude. The position information can be obtained when a function of a global positioning system (GPS) is disposed in for example a video camera. The area Country, the area Organization, and the area User describe a country name, an organization name, and a user name with abbreviated alphabetic characters and symbols.

When the foregoing extended UMID is used, the data length thereof is 64 bytes. Thus, when it is time-sequentially recorded, the capacity is relatively large. Thus, when the UMID is embedded in the time sequence meta data, it is preferred to compress the UMID in accordance with a predetermined system.

Next, an essence mark will be described in brief. An essence mark represents an index of a picture scene (or a cut) of video data that is photographed. For example, a photographing start mark that represents a record start position, a photographing end mark that represents a record end position, a shot mark that represents any position such as a considerable point, a cut mark that represents a cut position, and so forth are defined as essential marks. In addition, other information of a photographing operation such as a position at which a flash was lit and a position at which the shutter speed was changed may be defined as essence marks.

With essence marks, the user can know a photographed scene without need to perform a reproducing operation for the picture scene data. When essence marks are defined as reserved words, for example a photographing apparatus, a reproducing apparatus, an editing apparatus, and an interface can be controlled with the essence marks in common, not converted. In addition, when essence marks are used as index information in a coarse editing operation, desired picture scenes can be effectively selected.

Next, a data arrangement on a disc according to an embodiment of the present invention will be described. According to the embodiment of the present invention, data is recorded as if growth rings were formed on a disc. Hereinafter, such data is referred to as simply ring data. The ring data is recorded on a disc in the unit of a data amount represented by reproduction duration of data. Assuming that data recorded on a disc is only audio data and video data of main AV data, the audio data and the video data in a reproduction time zone are alternately placed every predetermined reproduction duration equivalent to a data size of one track or more. When audio data and video data are recorded in such a manner, sets of them are time-sequentially layered as rings.

According to the present embodiment, in addition to audio data and video data in a reproduction time zone, sub AV data and time sequence meta data in the reproduction time zone are recorded as a set. As a result, a ring is formed on an optical disc 1.

Data of a ring is referred to as ring data. Ring data has a data amount that is an integer multiple of a data amount of a sector that is the minimum recording unit of the disc. In addition, ring data is recorded so that the boundary thereof matches the boundary of a sector of the disc.

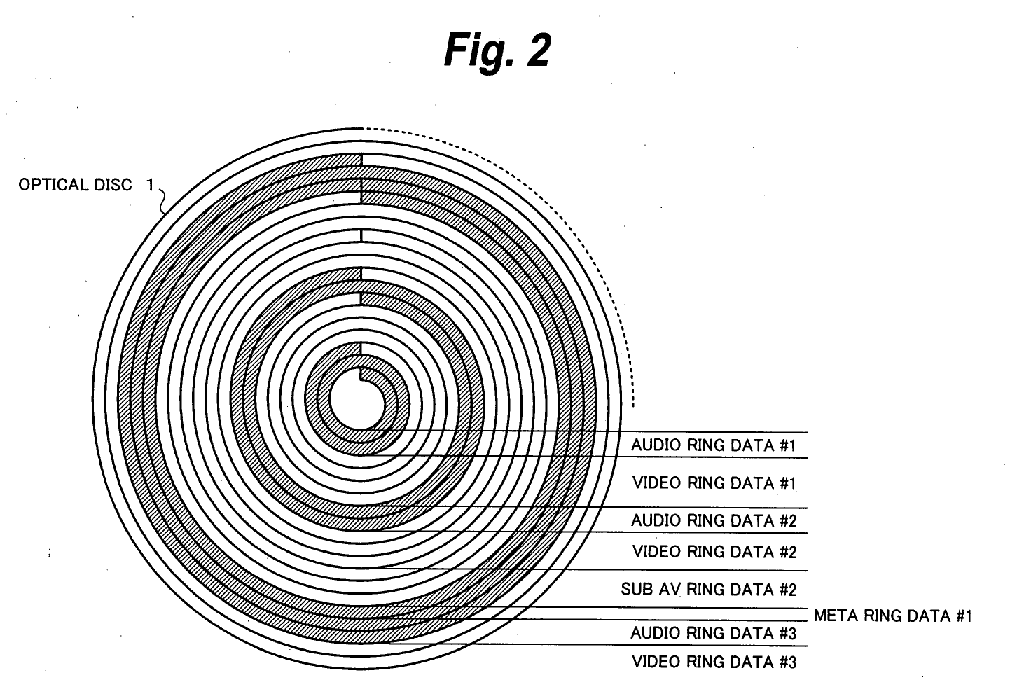

FIG. 2 shows an example of which ring data is formed on the optical disc 1. In the example shown in FIG. 2, audio ring data #1, video ring data #1, audio ring data #2, video ring data #2, sub AV ring data #1, and time sequence meta ring data #1 are recorded in the order from the inner periphery side. In such a cycle, ring data is treated. On the outer periphery side of the time sequence meta ring data #1, part of ring data of the next cycle is formed as audio ring data #3 and video ring data #3.

In the example shown in FIG. 2, a reproduction time zone of data of one cycle of time sequence meta ring data corresponds to that of sub AV ring data. A reproduction time zone of data of one cycle of time sequence meta ring data corresponds to that of two cycles of audio ring data. Likewise, a reproduction time zone of data of one cycle of time sequence metal ring data corresponds to that of two cycles of video data. The relation between a reproduction time zone and the number of cycles of each type of ring data depends on for example the data rate thereof. It is preferred that the reproduction duration of data of one cycle of video ring data and audio ring data should be experimentally around 1.5 to 2 seconds.

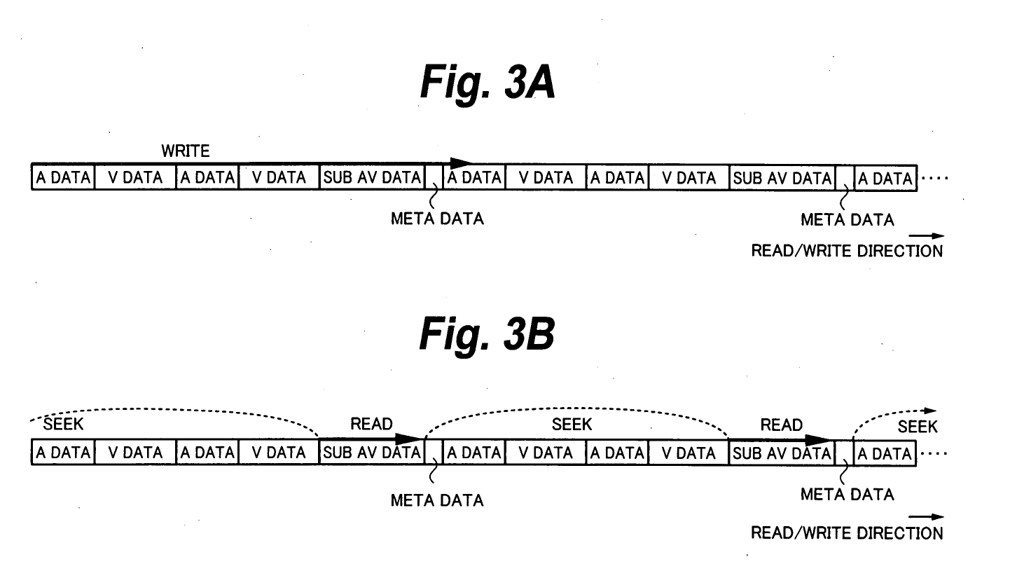

FIG. 3A and FIG. 3B show examples of which data is read from and written to the optical disc 1 on which rings are formed as shown in FIG. 2. When the optical disc 1 has a sufficient continuous error-free blank area, as shown in FIG. 3A, audio ring data, video ring data, sub AV ring data, and time sequence meta ring data generated from data sequences of audio data, video data, and sub AV data time sequence meta data in accordance with a reproduction time zone are written to a blank area of the optical disc 1 as if they were written in a single stroke. At that point, each type of data is written so that the boundary thereof matches the boundary of a sector of the optical disc 1. Data of the optical disc 1 is read in the same manner as it is written thereto.

On the other hand, when a predetermined data sequence is read from the optical disc 1, an operation for seeking the record position of the data sequence and reading the data is repeated. FIG. 3B shows an operation for selectively reading a sequence of sub AV data in such a manner. For example, with reference to FIG. 2, after the sub AV ring data #1 is read, the time sequence meta ring data #1, the audio ring data #3, the vide ring data #3, the audio ring data #4, and video ring data #4 (not shown) are sought and skipped. Thereafter, sub AV ring data #2 of the next cycle is read.

In such a manner, since data is recorded on the optical disc 1 cyclically as ring data in accordance with a reproduction time zone in the unit of a predetermined reproduction duration, audio ring data and video ring data in the same reproduction time zone are placed at close positions on the optical disc 1. Thus, audio data and video data in the same reproduction time zone can be quickly read and reproduced from the optical disc 1. In addition, since audio data and video data are recorded so that the boundary of a ring matches the boundary of a sector, only audio data or video data can be read from the optical disc 1. As a result, only audio data or video data can be quickly edited. In addition, as described above, the data amount of each of audio ring data, video ring data, sub AV ring data, and time sequence meta ring data is an integer multiple of the data amount of a sector of the optical disc 1. In addition, ring data is recorded so that the boundary thereof matches the boundary of a sector. Thus, when only one of sequences of audio ring data, video ring data, sub AV ring data, and time sequence meta ring data is required, only required data can be read without need to read other data.

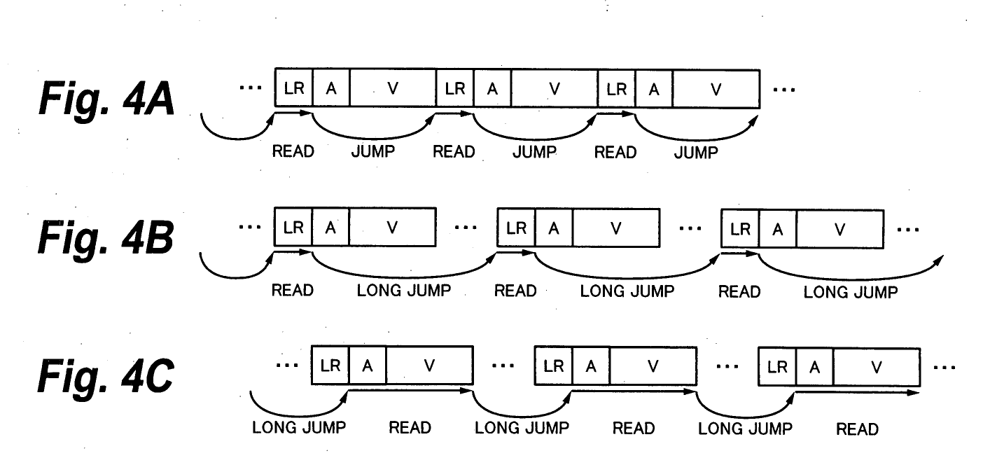

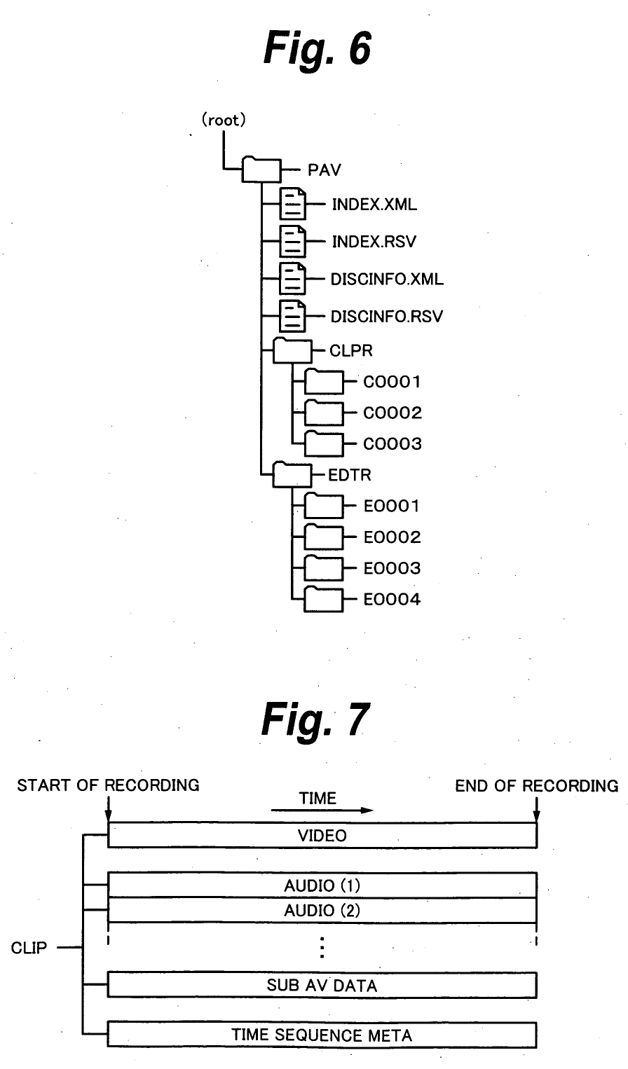

To effectively use the advantage of the data arrangement of rings of the optical disc 1, data should be recorded so that the continuity of rings is secured. An operation for securing the continuity of rings will be described with reference to FIG. 4A, FIG. 4B, and FIG. 4C. Now, it is assumed that only sub AV ring data (denoted by LR in FIG. 6) is read.

When data is recorded, if a large blank area is secured, a plurality of cycles of rings can be continuously recorded. In this case, as shown in FIG. 4A, chronologically successive sub AV ring data can be read by jumping a minimum number of tracks. In other words, after sub AV ring data is read, the next sub AV ring data can be read. Such an operation is repeatedly performed. As a result, the distance for which the pickup jumps becomes minimum.

In contrast, when data is recorded, if a successive blank area cannot be secured and chronologically continuous sub AV data is recorded in separate areas on the optical disc 1, as shown in FIG. 4B, after reading the first sub AV ring data, the pickup should jump for a distance of a plurality of cycles of rings so as to read the next sub AV ring data. Since such an operation is repeated, the read speed for sub AV ring data is decreased in comparison with the case shown in FIG. 4A. In addition, there is a possibility of which non-edited AV data (AV clip) may not be reproduced in real time as shown in FIG. 4C.

Thus, according to the embodiment of the present invention, an allocation unit having a length of a plurality of cycles of rings is defined so as to secure the continuity of rings. When data is recorded as rings, a continuous blank area that exceeds an allocation unit length defined by the allocation unit is secured.

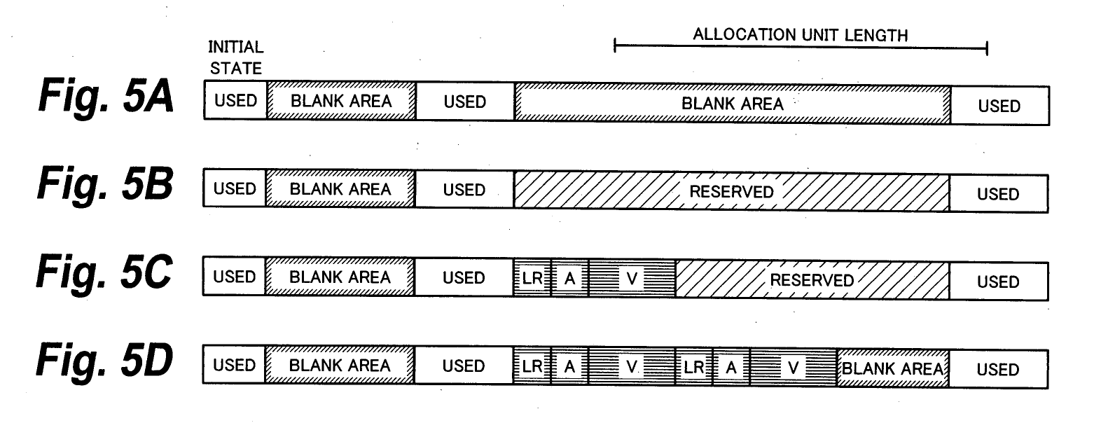

Next, with reference to FIG. 5A, FIG. 5B, FIG. 5C, and FIG. 5D, an operation for securing a successive blank area will be practically described. The allocation unit length is designated to a multiple of a total reproduction duration of individual types of data in one cycle of a ring. Assuming that the reproduction duration of one cycle of one ring is 2 seconds, the allocation unit length is designated to 10 seconds. The allocation unit length is used as a rule for measuring the length of a blank area of the optical disc 1 (see an upper right portion of FIG. 5A). As shown in FIG. 5A, it is assumed that there are three used areas that are separate areas on the optical disc 1 and that areas that are surrounded by the used areas are blank areas.

When AV data having a predetermined length and sub AV data corresponding thereto are recorded on the optical disc 1, the allocation unit length is compared with the lengths of blank areas and a blank area having a length equal to or larger than the allocation unit length is secured as a reserved area (see FIG. 5B). In the example shown in FIG. 5A, it is assumed that the right side blank area of the two blank areas is longer than the allocation unit length and secured as a reserved area. Thereafter, ring data is successively and continuously recorded to the reserved area from the beginning (see FIG. 5C). When the ring data is recorded and the length of the blank area of the reserved area is smaller than the length of one cycle of ring data that is recorded next (see FIG. 5D), the reserved area is unallocated. As shown in FIG. 5A, another bank area that is equal to or larger than the allocation unit length is searched for a reserved area.

Since a blank area for a plurality of cycles of rings is sought and the rings are recorded in the sought blank area, the continuity of the rings is secured to some extent. As a result, ring data can be smoothly reproduced. In the foregoing example, it was assumed that the allocation unit length is designated to 10 seconds. The present invention is not limited to such an example. Instead, a longer time period can be designated as the allocation unit length. In reality, it is preferred that the allocation unit length should be designated in the range from 10 to 30 seconds.

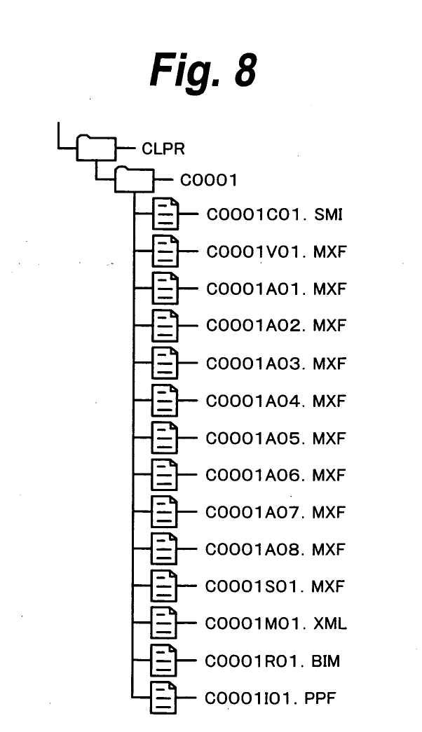

Next, with reference to FIG. 6, FIG. 7, and FIG. 8, a data management structure according to the embodiment of the present invention will be described. According to the embodiment of the present invention, data is managed in a directory structure. In the directory structure, for example, the universal disk format (UDF) is used as a file system. As shown in FIG. 6, immediately below a root directory (root), a directory PAV is placed. According to the present embodiment, sub directories of the directory PAV will be defined.

In other words, audio data and video data of a plurality of types of signals recorded on one disc are defined below the directory PAV. Data can be freely recorded to the directory PAV that is not managed corresponding to the embodiment of the present invention.

Immediately below the directory PAV, four files (INDEX.XML, INDEX.RSV, DISCINFO.XML, and DISCINFO.RSV) are placed. In addition, two directories (CLPR and EDTR) are placed.

The directory CLIP serves to manage clip data. In this example, a clip is a block of data recorded after a photographing operation is started until it is stopped. For example, in an operation of a video camera, data recorded after an operation start button is pressed until an operation stop button is pressed (the operation start button is released) is one clip.

In this example, a block of data is composed of the foregoing main audio data and main video data, sub AV data generated with the main audio data and main video data, time sequence meta data corresponding to the main audio data and main video data, and no-time sequence meta data. Directories “C0001”, “C0002”, . . . immediately below the directory CLPR each store a block of data that composes a clip.

In other words, as shown in FIG. 7, one clip is composed of video data, audio data of channels (1), (2), . . . , sub AV data, time sequence meta data, and non-time sequence meta data on the common time base after the recording operation is started until it is stopped. In FIG. 7, the non-time sequence meta data is omitted.

FIG. 8 shows an example of the structure of the directory “C0001” for one clip “C0001” placed immediately below the directory CLPR. In the following description, a directory for one clip placed immediately below the directory CLPR is referred to as clip directory. Each member of data that composes a block of data is identified by a file name and placed in the clip directory “C0001”. In the example shown in FIG. 8, a file name is composed of 12 digits. The first five digits of eight digits preceded by a delimiter “.” are used to identify a clip. The three digits immediately followed by the delimiter are used to identify data type such as audio data, video data, and sub AV data. The three digits preceded by the delimiter are an extension that represents a data format.

In reality, in the example shown in FIG. 8, as a block of files that compose the clip “C0001”, a file “C001C01.SMI” for clip information, a main video data file “C0001V01.MXF”, main audio data files of eight channels “C0001A01.MXF” to “C0001A08.MXF”, a sub AV data file “C0001S01.MXF”, a non-time sequence meta data file “C0001M01.XML”, a time sequence meta data file “C0001R01.BIM”, and a pointer information file “C0001I01.PPF” are placed in the clip directory “C0001”.

Returning to FIG. 6, the directory EDTR serves to manage edit information. According to the embodiment of the present invention, an edit result is recorded as an edit list and a play list. Blocks of data each of which composes an edit result are placed in directories “E0001”, “E0002”, . . . placed immediately below the directory EDTR.

An edit list describes edit points (IN points, OUT points, etc.) of clips, a reproduction order thereof, and so forth. An edit list is composed of a nondestructively edit result of clips and a play list that will be described later. When a nondestructively edit result of an edit list is reproduced, files placed in a clip directory are referenced in accordance with the description of the list and a plurality of clips are successively reproduced as if one edited stream were reproduced. However, for a nondestructively edit result, files are referenced from the list regardless of the positions of the files on the optical disc 1. Thus, files cannot be securely reproduced in real time.

When an edit result represents that files or a part thereof that are referenced by a list cannot be reproduced in real time, the files or part thereof is reallocated in a predetermined area of the optical disc 1. As a result, an edit list is securely reproduced in real time.

In accordance with an edit list created by an editing operation, management information of files that are used for the editing operation (for example, an index file “INDEX.XML” that will be described later) is referenced. With reference to the management information, it is determined whether or not files that are referenced can nondestructively be reproduced in real time namely in the state that the files that are referenced in accordance with the edit result are placed in respective clip directories. When the determined result represents that the files cannot be reproduced in real time, a relevant file is reallocated to a predetermined area of the optical disc 1. A file reallocated to the predetermined area is referred to as bridge clip. In addition, a list of which a bridge clip is reflected to an edit result is referred to as play list.

For example, if an edit result references clips in a complicated manner, when one clip is changed to the next clip, the pickup may not be able to seek the next clip until it is reproduced. In such a case, a play list is created. The bridge clip that allows clips to be reproduced in real time is recorded in a predetermined area of the optical disc 1. A play list that represents a reproducing method in accordance with the bridge clip is created.

When clips cannot be reproduced in real time, a bridge clip is created. Thus, a bridge clip may be created for any of main AV data, sub AV data, and meta data. Of course, a bridge clip may be created for audio data as well as video data. In addition, when video data is not compressed by inter-frame compression, if a disc defect takes place or blank areas are dispersed by repeated recording and erasing operations, clips may not be reproduced in real time. At that point, a bridge clip is created.

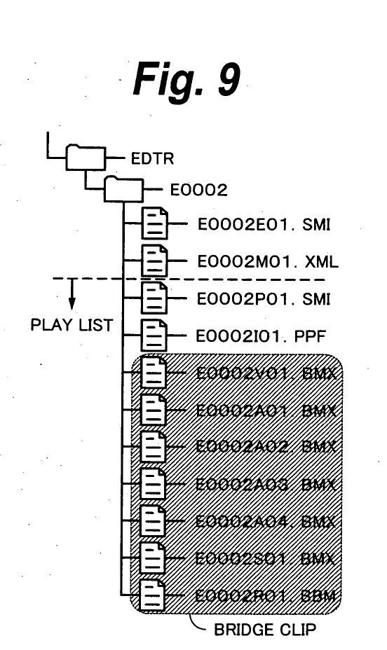

FIG. 9 shows an example of the structure of the directory “E0002” corresponding to an edit result “E0002”, the directory “E0002” being placed immediately below the directory EDTR. Hereinafter, a directory corresponding to one edit result and placed immediately below the directory EDTR is referred to as edit directory. Data generated as an edit result in the foregoing manner is identified by a file name and placed in the edit directory “E0002”. As mentioned above, a file name is composed of 12 digits. The first five digits of eight digits followed by the delimiter are used to identify an editing operation. The tree digits immediately followed by the delimiter are used to identify a file type. The three digits preceded by the delimiter are an extension that identifies a data format.

In reality, in the example shown in FIG. 9, as files that compose the edit result “E0002”, an edit list file “E0002E01.SM1”, a file “E0002M01.XML” for information of time sequence and non-time sequence meta data, a play list file “E0002P01.SMI”, bridge clips for main data “E0002V01.BMX” and “E0002A01.BMX” to “E0002A04.BMX”, a sub AV data bridge clip “E0002S01.BMX”, and a bridge clip for time sequence and non-time sequence meta data “E0002R01.BMX” are placed in the edit directory “E0002”.

In FIG. 9, shaded files placed in the edit directory “E0002”, namely the bridge clips for main data “E000V01.BMX” and “E0002A01.BMX” to “E0002A04.BMX”, the bridge clip for sub AV data “E0002S01.BMX” and the bridge clip for time sequence and non-time sequence meta data “E0002R01.BMX” are files contained in the play list.

Returning to FIG. 6, the file “INDEX.XML” is an index file that serves to manage material information placed below the directory PAV. In this example, the file “INDEX.XML” is described in the extensible markup language (XML) format. The file “INDEX.XML” serves to manage the foregoing clips and edit list. For example, with the file “INDEX.XML”, a conversion table of file names and UMIDs, duration information (Duration), a reproduction order of materials reproduced from the optical disc 1, and so forth are managed. In addition, with the file “INDEX.XML”, video data, audio data, sub AV data, and so forth of each clip are managed. Moreover, with the file “INDEX.XML”, clip information managed with files in a clip directory is managed.

The file “DISCINFO.XML” serves to manage information of the disc. Reproduction position information and so forth are also placed in the file “DISCINFO.XML”.

The naming rule of a clip directory name and a file name of each file placed in a clip directory is not limited to the foregoing example. For example, as a file name and a clip directory name, the foregoing UMID may be used. As described above, when an extended UMID is used, the data length thereof is as large as 64 bytes. Thus, since it is long for a file name, it is preferred to use a part of a UMID. For example, a portion that is unique for each clip in a UMID is used for a file name.

When a clip is divided, it is preferred that clip directory names and file names should be designated so that the clip dividing reason is affected to the clip directory names and file names from a viewpoint of management of clips. In this case, clip directory names and file names are designated so that it can be determined whether a clip was intentionally divided by the user or automatically divided on the device side.

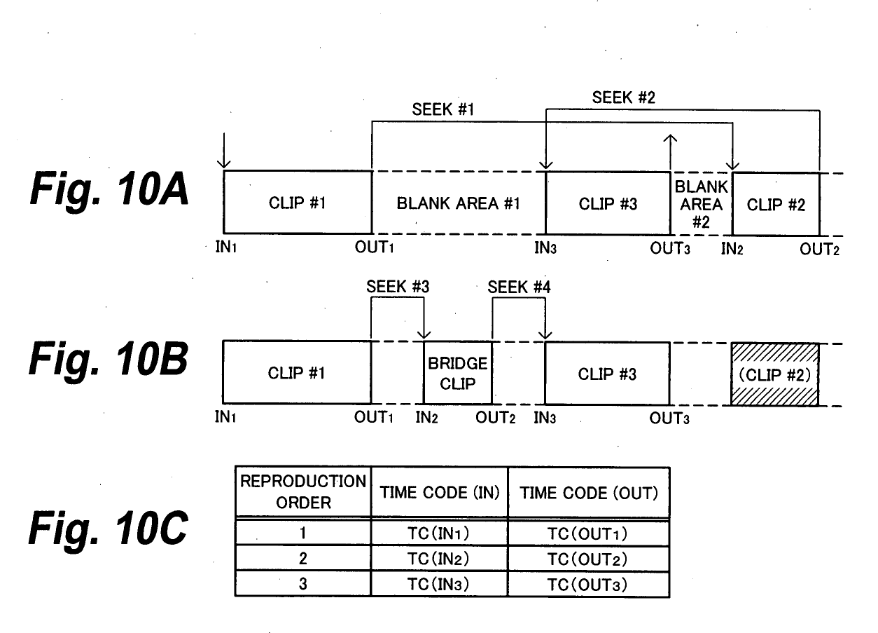

Next, an edit list and a bridge clip will be described. First of all, with reference to FIG. 10A, FIG. 10B, and FIG. 10C, a bridge clip will be conceptually described. In FIG. 10A and FIG. 10B, it is assumed that data is read from the disc and written to thereto in the right direction.

A bridge clip should be created when AV data is reproduced from separated areas on a disc if seek time for which the pickup moves from one area to the other area is large and a buffer underflow will take place.

The buffer underflow represents a state of which when all data stored in a buffer memory that absorbs the difference between the recording and reproducing speed of the disc the transfer rate of the audio data has been read, next data has not been stored in the buffer memory. In such a state, since the decoder cannot successively decode data that is read from the disc, since reproduction of AV data stops, the AV data cannot be reproduced in real time.

As shown in FIG. 10A, it is assumed that a clip #1, a clip #2, and a clip #3 are recorded on the disc. In addition, it is assumed that as edit points an IN₁ point and an OUT₁ point, an IN₂ point and an OUT₂ point, and an IN₃ point and an OUT₃ point have been designated to the clips #1, #2, and #3, respectively. In this example, for easy understanding, it is assumed that an IN point and an OUT point have been designated to the beginning and the end of each clip. In the example shown in FIG. 10A, a blank area #1 is formed between the clip #1 and the clip #2. When data is repeatedly recorded to the disc and reproduced therefrom, such an blank area may be formed between data blocks recorded on the disc.

In such a state, as shown in FIG. 10A, it is assumed that AV data is reproduced from the IN₁ point to the OUT₁ point (clip #1), then AV data is reproduced from the IN₂ point to the OUT₂ point (clip #2) placed after the IN₃ point and the OUT₃ point, and then AV data is reproduced from the IN₃ point to the OUT₃ point (clip #3) placed before the clip #2.

In other words, AV data is reproduced in accordance with an edit list shown in FIG. 10C. In FIG. 10C, TC(IN₁) represents a time code of the IN₁ point designated to the clip #1. TC(OUT₁) represents a time code of the OUT₁ point designated to the clip #1. Likewise, TC(IN₂) and TC(OUT₂) represent time codes of the IN₂ point and the OUT₂ point designated to the clip #2, respectively. TC(IN₃) and TC(OUT₃) represent time codes of the IN₃ point and the OUT₃ point designated to the clip #2, respectively.

In accordance with an edit list shown in FIG. 10C, AV data from a picture designated by TC(IN₁) to a picture designated by TC(OUT₁) is reproduced. Thereafter, AV data from a picture designated by TC(IN₂) to a picture designated by TC(OUT₂) is reproduced. Thereafter, AV data from a picture designated by TC(IN₃) to a picture designated by TC(OUT₃) is reproduced. In such a manner, AV data shown in FIG. 10A is reproduced in accordance with the edit list.

In FIG. 10A, since the clip #1, the clip #2, and the clip #3 are recorded in separate areas, when they are reproduced in accordance with the edit list shown in FIG. 10C, the pickup moves from the OUT₁ point of the clip #1 to the IN₂ point of the clip #2. As a result, the seek #1 takes place. When the pickup moves from the OUT₂ point of the clip #2 to the IN₃ point of the clip #3, the seek #2 takes place. When the seek times of the seek #1 and the seek #2.are large, the AV data that is read from the disc cannot be reproduced in real time. As a result, the foregoing buffer underflow takes place. Thus, the reproduction of the AV data stops.

The disc recording and reproducing apparatus has a buffer memory and a decoder. As described above, the buffer memory temporarily stores AV data that is read from a disc. The decoder decodes the AV data that is read from the buffer. While the pickup seeks AV data, if the decoder has fully read the AV data that has been buffered and a buffer underflow takes place, the real time reproduction stops. In other words, to secure the real time reproduction, when a seek takes place, AV data required during the seek should have been stored in the buffer.

To do that, a part of a clip is reallocated to a blank area. The reallocated bridge clip is treated as AV data to be reproduced. As a result, the real time reproduction of the disc recording and reproducing apparatus is secured.

When the AV data shown in FIG. 10A is reproduced in accordance with an edit list, if it has been determined that a buffer underflow takes place while the seek #1 or the seek #2 takes place, a clip to be sought (in the example, clip #2) is reallocated to the blank area #1. As a result, a bridge clip is created. When the bridge clip is created, a play list is created in accordance with the content of the bridge clip. In addition, the edit list is rewritten so that the play list is reflected by the bridge clip.

When a bridge clip is created in such a manner and a reproducing operation is performed in accordance with the edit list shown in FIG. 10C, the seek #3 and the seek #4 are performed as shown in FIG. 10B. Although the same clips are reproduced in the same order as shown in FIG. 10A, it is clear that the seek time in the case that a bridge clip is created as shown in FIG. 10B is much shorter than that shown in FIG. 10A.

According to the embodiment of the present invention, as described above, sub AV data is created in accordance with main AV data. The created sub AV data is recorded along with main AV data. The sub AV data recorded on the disc is used to search main AV data with a shuttle operation and quickly transmit video data that has been photographed at a reporting site and simply edited to a broadcasting station to a broadcasting station having a relatively low transmission rate.

Thus, it is required that an edit point of main AV data should match an edit point of sub AV data. When main AV data is edited, sub AV data is automatically edited. At that point, there is a possibility of which a bridge clip should be created for at least one of main AV data and sub AV data.

According to the present invention, a bridge clip of sub AV data is created with main AV data. Thus, the picture quality of a bridge clip of sub AV data can be kept constant against the sub AV data.

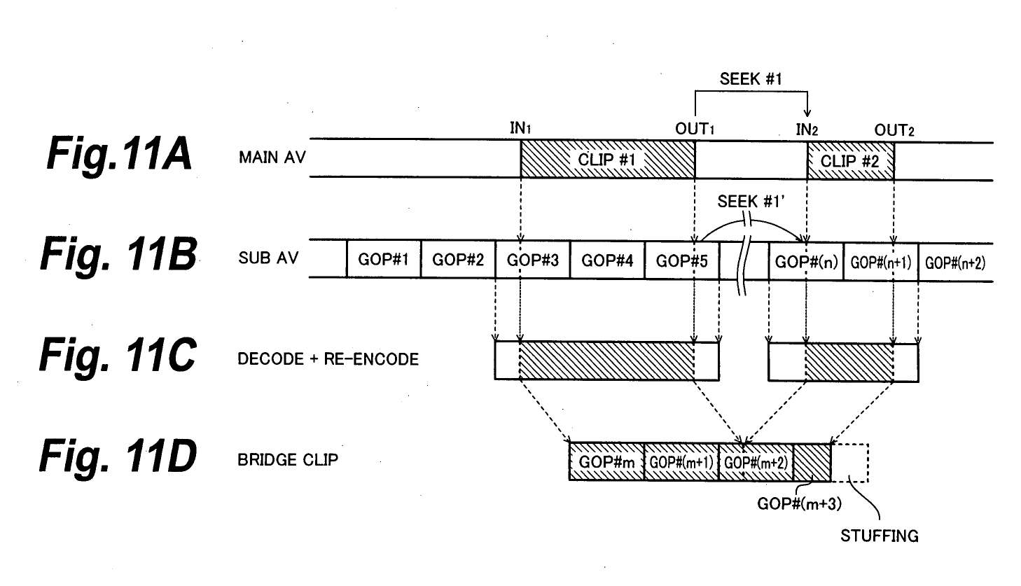

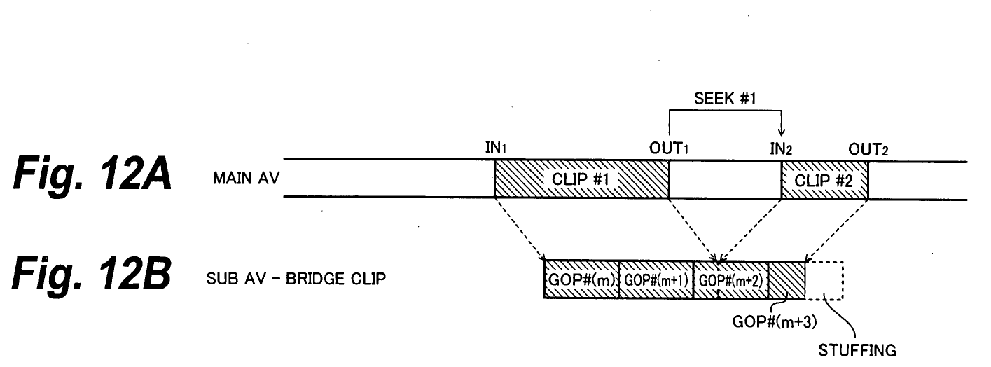

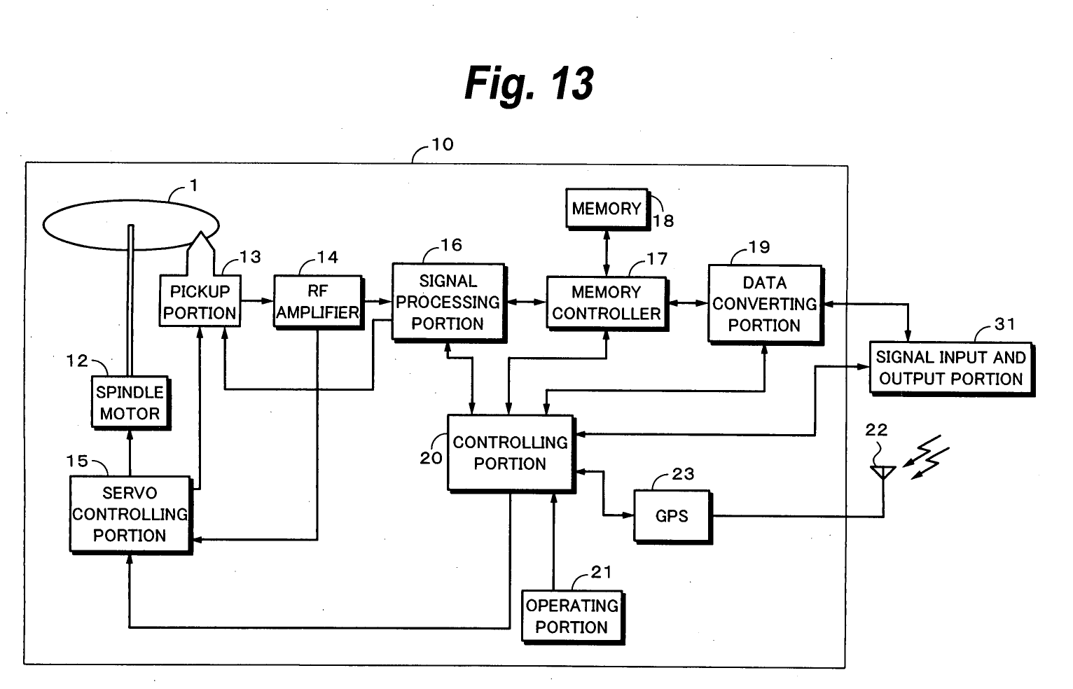

Next, with reference to FIG. 11A, FIG. 11B, FIG. 11C, and FIG. 11D and FIG. 12A and FIG. 12B, a bridge clip that is created for sub AV data that is edited in accordance with main AV data will be described. FIG. 11A to FIG. 11D show an example of a method for creating a bridge clip for sub AV data with the sub AV data itself. FIG. 12A and FIG. 12B show a method for creating a bridge clip for sub AV data with main AV data.

In reality, in each of main AV data and sub AV data, audio data and video data are recorded in different areas. Thus, bridge clips are separately created for audio data and video data. However, for simplicity, in the following description, it is assumed that a bridge clip is created for a set of audio data and video data (AV data).

First of all, with reference to FIG. 11A to FIG. 11D, a method for creating a bridge clip for sub AV data with sub AV data itself will be described. FIG. 11A shows main AV data. FIG. 11B shows sub AV data corresponding to main AV data shown in FIG. 11A. In FIG. 11A to FIG. 11D, data is read from the disc and written thereto in the left direction. In main AV data shown in FIG. 11A, as described above, since one GOP is composed of one picture, an edit point can be designated in the unit of one frame. In the example shown in FIG. 11A, as edit points, an IN₁ point, an OUT₁ point, an IN₂ point, and an OUT₂ point are designated. A range designated by the IN₁ point and the OUT₁ point is represented as a clip #1. A range designated by the IN₂ point and the OUT₂ point is represented by a clip #2. Although the description of an edit list will be omitted, the range from the IN₁ point to the OUT₁ point is reproduced. Thereafter, the range from the OUT₁ point to the IN₂ point is sought as the seek #1. The range from the IN₂ point to the OUT₂ point is reproduced. In the example, it is assumed that while the seek #1 takes place in the main AV data, a buffer underflow does not take place.

On the other hand, as described above, in sub AV data, one GOP is composed of one I picture and nine P pictures. In the example shown in FIG. 11B, edit points of sub AV data corresponding to the IN₁ point and the OUT₁ point of main AV data are placed in GOP#3 and GOP#5. On the other hand, edit points of sub AV data corresponding to the IN₂ point and the OUT₂ point of main AV data are placed in GOP#(n) and GOP#(n+1). In addition, it is assumed that while the seek #1 takes place for which the pickup moves from GOP#5 to GOP#(n) a buffer underflow takes place and the reproduction of sub AV data stops. When the sub AV data is reproduced in accordance with such an edit result, a bridge clip for sub AV data is required to reproduce the sub AV data in the range from the OUT₁ point to the In₂ point.

In the example, each edit point designated to main AV data does not match a boundary of a GOP of sub AV data. Since other than an I picture of pictures that compose a GOP do not complete an image, to create a bridge clip for sub AV data at a position corresponding to an edit point of main AV data, as shown in FIG. 11C, it is necessary to temporarily decode sub AV data and restore pictures of frames. After sub AV data is decoded and pictures of frames are restored, frames in the range designated by edit points of main AV data are collected and re-encoded. As shown in FIG. 11D, GOPs are restructured. As a result, a bridge clip is created with sub AV data.

When a bridge clip for sub AV data is created with sub AV data itself, sub AV data that has been compression-encoded at a high compression rate is decoded. As a result, frames are restored. The restored frames are compression-encoded at a high compression rate. Thus, the picture quality of the created bridge clip is lower than that of the original sub AV data. Thus, the picture quality of the created bridge clip is much lower than that of the corresponding main AV data.

Next, with reference to FIG. 12A and FIG. 12B, a method for creating a bridge clip for sub AV data according to the present invention will be described. FIG. 12A shows edit points (an IN₁ point, an OUT₁ point, an IN₂ point, and an OUT₂ point) designated to main AV data like those shown in FIG. 11A. Sub AV data (not shown in FIG. 12A) corresponding to the main AV data is the same as that shown in FIG. 11B.

As described above, in the main AV data shown in FIG. 12A, one GOP is composed of one I picture. One GOP corresponds to one frame. Frames namely 1 pictures in ranges (clip #1 and a clip #2) designated by edit points for the main AV data, namely an IN₁ point, an OUT₁ point, an IN₂ point, and an OUT₂ point are treated as one successive bridge clip. The bridge clip of frames of main AV data is compression-encoded in accordance with the system for sub AV data. As a result, one I picture and nine P pictures are created. As shown in FIG. 12B, GOPs for sub AV data are structured. GOP#m to GOP#(m+3) created in such a manner become a bridge clip for sub AV data.

In such a method, a bridge clip for sub AV data can be directly created from main AV data having a high resolution without need to perform an decoding process and a re-encoding process for the sub AV data. Thus, a bridge clip for sub AV data can be created with a higher picture quality than the case that sub AV data is decoded and re-encoded.

A bridge clip for main AV data and a bridge clip for sub AV data are independently created in accordance with conditions of their positions on the disc. Normally, a bridge clip for one of main AV data and sub AV data is created.

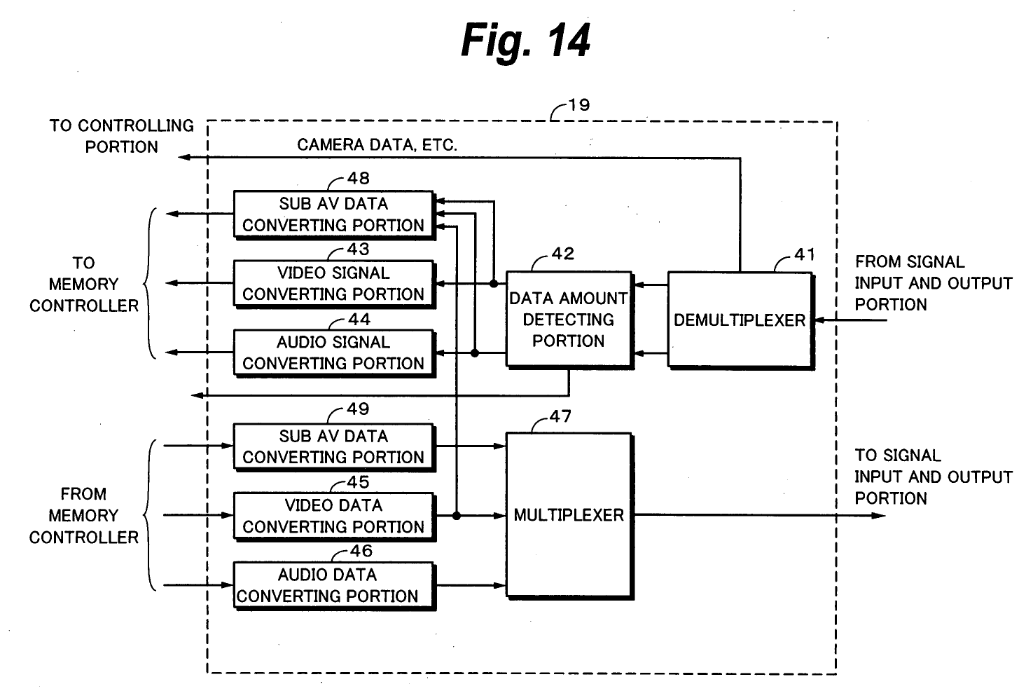

FIG. 13 shows an example of the structure of a disc recording and reproducing apparatus 10 according to an embodiment of the present invention. In this example, the disc recording and reproducing apparatus 10 is a recording and reproducing portion that is built in a video camera (not shown). A video signal corresponding to a photographing signal photographed by the video camera and an audio signal that is input corresponding to the photographing operation are input to a signal processing portion 31 and supplied to the disc recording and reproducing apparatus 10. The video signal and the audio signal that are output from a signal input and output portion 31 are supplied to for example a monitor device.

Of course, that structure is an example. In other words, the disc recording and reproducing apparatus 10 may be a device that is independent from a video camera. For example, the disc recording and reproducing apparatus 10 may be used together with a video camera that does not have a recording portion. A video signal, an audio signal, a predetermined control signal, and data that are output from a video camera are input to the disc recording and reproducing apparatus 10 through the signal input and output portion 31. Alternatively, a video signal and an audio signal that are reproduced by another recording and reproducing apparatus may be input to the signal input and output portion 31. In addition, an audio signal that is input to the signal input and output portion 31 may be not limited to an audio signal that is input along with a video signal. In other words, an audio signal may be an after-recording audio signal of which an audio signal is recorded to a predetermined region of a video signal.

A spindle motor 12 drives rotations of the optical disc 1 at constant linear velocity (CLV) or constant angular velocity (CAV) in accordance with a spindle motor drive signal received from a servo controlling portion 15.

A pickup portion 13 controls an output of laser light in accordance with a record signal supplied from a signal processing portion 16 and records the record signal to the optical disc 1. The pickup portion 13 focuses irradiated laser light on the optical disc 1. In addition, the pickup portion 13 converts light reflected from the optical disc 1 into electricity and generates a current signal. The current signal is supplied to a radio frequency (RF) amplifier 14. The irradiated position of the laser light is controlled to a predetermined position in accordance with a servo signal supplied from the servo controlling portion 15 to the pickup portion 13.

The RF amplifier 14 generates a focus error signal, a tracking error signal, and a reproduction signal in accordance with a current signal supplied from the pickup portion 13. The RF amplifier 14 supplies the tracking error signal and the focus error signal to the servo controlling portion 15. The RF amplifier 14 supplies the reproduction signal to the signal processing portion 16.

The servo controlling portion 15 controls a focus servo operation and a tracking servo operation. In reality, the servo controlling portion 15 generates a focus servo signal and a tracking servo signal in accordance with the focus error signal and the tracking error signal supplied from the RF amplifier 14 and supplies the generated signals to an actuator (not shown) of the pickup portion 13. In addition, the servo controlling portion 15 generates a spindle motor drive signal that causes the spindle motor 12 to be driven and controls a spindle servo operation for rotating the optical disc 1 at a predetermined rotation speed with the spindle motor drive signal.

In addition, the servo controlling portion 15 performs a thread control for moving the pickup portion 13 in the radius direction of the optical disc 1 and changing the irradiation position of the laser light. The signal read position of the optical disc 1 is designated by a controlling portion 20. The controlling portion 20 controls the position of the pickup portion 13 so that a signal can be read from the designated read position.

The signal processing portion 16 modulates a record signal that is input from a memory controller 17 and supplies the generated signal to the pickup portion 13. In addition, the signal processing portion 16 demodulates the reproduction signal supplied from the RF amplifier 14 and supplies the generated data to the memory controller 17.

The memory controller 17 controls a write address of a memory 18 and stores record data supplied from a data converting portion 19 to the memory 18. In addition, the memory controller 17 controls a read address of the memory 18 and supplies data stored in the memory 18 to the signal processing portion 16. Likewise, the memory controller 17 stores reproduction data supplied from the signal processing portion 16 to the memory 18. In addition, the memory controller 17 reads data from the memory 18 and supplies the data to the data converting portion 19. In other words, the memory 18 is a buffer that stores data that is read from and written to the optical disc 1.

A video signal and an audio signal corresponding to a picture photographed by the video camera are supplied to the data converting portion 19 through the signal input and output portion 31. As will be described later, the data converting portion 19 compression-encodes the supplied video signal in accordance with a compression-encoding system such as the MPEG2 system in a mode designated by the controlling portion 20 and outputs main video data. At that point, the data converting portion 19 performs a compression-encoding process for the video signal at a higher compression rate and outputs sub AV data having a lower bit rate than the main video data.

In addition, the data converting portion 19 compression-encodes the supplied audio signal in accordance with a system designated by the controlling portion 20 and outputs main audio data. Alternatively, an audio signal may be output as linear PCM audio data that has not been compression-encoded.

The main audio data, the main video data, and the sub AV data that have been processed by the data converting portion 19 in the foregoing manner are supplied to the memory controller 17.

When necessary, the data converting portion 19 decodes the reproduction data supplied from the memory controller 17, converts the decoded data into a predetermined format output signal, and supplies the converted signal to the signal input and output portion 31.

The controlling portion 20 comprises a central processing unit (CPU), memories such as a read-only memory (ROM) and a random access memory (RAM), and a bus that connects these devices. The controlling portion 20 controls the entire disc recording and reproducing apparatus 10. The ROM pre-stores an initial program that is read when the CPU gets started and a program that controls the disc recording and reproducing apparatus 10. The RAM is used as a work memory of the CPU. In addition, the controlling portion 20 controls the video camera portion.

In addition, the controlling portion 20 provides a file system that records data to the optical disc 1 in accordance with a program this is pre-stored in the ROM and reproduces data from the optical disc 1. In other words, the disc recording and reproducing apparatus 10 records data to the optical disc 1 and reproduces data therefrom under the control of the controlling portion 20.

An operating portion 21 is operated by for example the user. The operating portion 21 supplies an operation signal corresponding to the operation to the controlling portion 20. The controlling portion 20 controls the servo controlling portion 15, the signal processing portion 16, the memory controller 17, and the data converting portion 19 in accordance with the operation signal and so forth received from the operating portion 21 and executes a recording and reproducing process.

For example, a command for editing AV data recorded on the optical disc 1 can be issued to the operating portion 21. A control signal corresponding to the edit command issued to the operating portion 21 is supplied to the controlling portion 20. The controlling portion 20 controls each portion of the disc recording and reproducing apparatus 10 in accordance with the control signal corresponding to the edit command and performs an editing process for the AV data recorded on the optical disc 1. At that point, the controlling portion 20 determines whether or not a bridge clip should be created in accordance with a data arrangement on the optical disc 1.

In addition, the disc recording and reproducing apparatus 10 has an antenna 22 that receives a GPS signal and a GPS portion 23 that analyzes the GPS signal received by the antenna 22 and outputs position information of latitude, longitude, and altitude. The position information that is output from the GPS portion 23 is supplied to the controlling portion 20. The antenna 22 and the GPS portion 23 may be disposed in the video camera portion. Alternatively, the antenna 22 and the GPS portion 23 may be disposed as external devices of the disc recording and reproducing apparatus 10.

FIG. 14 shows an example of the structure of the data converting portion 19. When data is recorded to the optical disc 1, a signal that is input from the signal input and output portion 31 is supplied to a demultiplexer 41. A video signal of a moving picture and an audio signal corresponding to the video signal are input from the video camera portion to the signal input and output portion 31. In addition, photographing information of the camera for example information of iris and zoom are input as camera data in real time.

The demultiplexer 41 separates a plurality of data sequences for example a video signal of a moving picture and an audio signal corresponding thereto from a signal supplied from the signal input and output portion 31 and supplies the separated signals to a data amount detecting portion 42. In addition, the demultiplexer 41 separates camera data from the signal supplied from the signal input and output portion 31 and supplies the camera data to the controlling portion 20.

The data amount detecting portion 42 supplies the video signal and the audio signal supplied from the demultiplexer 41 to a video signal converting portion 43, an audio signal converting portion 44, and a sub AV data converting portion 48. In addition, the data amount detecting portion 42 detects a data amount for a predetermined reproduction duration for each of the video signal and audio signal supplied from the demultiplexer 41 to the memory controller 17.

The video signal converting portion 43 compression-encodes the video signal supplied from the data amount detecting portion 42 in accordance with for example the MPEG2 system under the control of the controlling portion 20 and supplies the resultant data sequence of video data to the memory controller 17. The controlling portion 20 designates a maximum bit rate of one frame that has been compression-encoded for the video signal converting portion 43. The video signal converting portion 43 estimates the data amount of one frame that has been compression-encoded, controls a compression-encoding process corresponding to the estimated result, and performs a real compression-encoding process for the video data so that the generated code amount does not exceed the designated maximum bit rate. The video signal converting portion 43 fills the difference between the designated maximum bit rate and the real compression-encoded data amount with a predetermined amount of pudding data so as to keep the maximum bit rate. The video signal converting portion 43 supplies the data sequence of the video data that has been compression-encoded to the memory controller 17.

When the audio signal supplied from the data amount detecting portion 42 is not linear PCM audio data, the audio signal converting portion 44 converts the audio signal into linear PCM audio data under the control of the controlling portion 20. Alternatively, the audio signal converting portion 44 can compression-encode audio signal in accordance with for example the MP3 (Moving Picture Experts Group 1 Audio Layer 3) system or the AAC (Advanced Audio Coding) system of the MPEG system. It should be noted that the compression-encoding system for audio data is not limited to the foregoing examples. A data sequence of audio data that is output from the audio signal converting portion 44 is supplied to the memory controller 17.

On the other hand, the sub AV data converting portion 48 compression-encodes the video signal supplied from the data amount detecting portion 42 in accordance with for example the MPEG4 system under the control of the controlling portion 20 and outputs sub AV data. According to the present embodiment, at that point, the bit rate is fixed to several Mbps. One GOP is composed of a total of 10 pictures that are one I picture and nine P pictures.

Main AV data that is output from a video data converting portion 45 (that will be described later) disposed on the reproduction side of the data converting portion 19 is supplied to the sub AV data converting portion 48. Thus, when sub AV data is edited, a bridge clip for sub AV data can be created with main AV data. Alternatively, data on an input side of the video data converting portion 45 may be supplied to the sub AV data converting portion.

The foregoing structure is an example of the present invention. When main AV data, camera data, and so forth are independently input to the signal input and output portion 31, the demultiplexer 41 can be omitted. When the main AV data is linear PCM audio data, the process performed in the audio signal converting portion 44 can be omitted.

The video data and audio data supplied to the memory controller 17 are supplied and recoded on the optical disc 1 in the foregoing manner.

Data is recorded as rings on the optical disc 1. When the data amount detecting portion 42 of the data converting portion has detected an amount of audio data for a duration of one ring, the data amount detecting portion 42 informs the memory controller 17 of that. When the memory controller 17 has been informed of that, it determines whether or not it has stored audio data for a duration of one ring to the memory 18 and informs the controlling portion 20 of the determined result. The controlling portion 20 causes the memory controller 17 to read audio data for a duration of one ring from the memory 18. The memory controller 17 reads audio data from the memory 18 under the control of the controlling portion 20 and records the audio data on the optical disc 1.

When audio data for a reproduction duration of one ring has been recorded, the same process is performed for video data. The video ring data for one ring is immediately preceded by the audio ring data. Likewise, sub AV data for a reproduction duration of one ring is successively recorded.

Time sequence meta data for example camera data is supplied from the demultiplexer 41 to the controlling portion 20. Several types of time sequence meta data for example a UMID are created by the controlling portion 20. Camera data and data created by the controlling portion 20 are treated together as time sequence meta data. The time sequence meta data is stored in the memory 18 through the memory controller 17. The memory controller 17 reads time sequence meta data for a reproduction duration of one ring from the memory 18 and supplies the time sequence meta data to the signal processing portion 16.

On the other hand, when data is reproduced from the optical disc 1, video data, audio data of each channel, sub AV data, and time sequence meta data are read from the optical disc 1. At that point, main audio data, sub AV data, and time sequence meta data that are low bit rate data are reproduced at a high bit rate of main video data so that the reproduction speed of data that is read from the optical disc 1 is not varied depending on the type of data that is read therefrom. Video data and sub AV data that are read from the optical disc 1 are supplied from the memory controller 17 to the video data converting portion 45 and a sub AV data converting portion 49. The audio data is supplied from the memory controller 17 to an audio data converting portion 46.

The video data converting portion 45 decodes a data sequence of main video data supplied from the memory controller 17 and supplies the obtained video signal to a multiplexer 47. In addition, as described above, an output of the video data converting portion 45 is also supplied to the sub AV data converting portion 48 disposed on the record side of the data converting portion 19. Alternatively, data on the input side of the video data converting portion 45 may be supplied to the foregoing sub AV data converting portion 48.

The sub AV data converting portion 49 decodes a data sequence of sub AV data supplied from the memory controller 17 and supplies the obtained video signal and audio signal to the multiplexer 47.

In addition, the audio data converting portion 46 decodes a data sequence of audio data supplied from the memory controller 17 and supplies the obtained audio signal to the multiplexer 47.

The video data converting portion 45, the audio data converting portion 46, and the sub AV data converting portion 49 may supply received reproduction data to the multiplexer 47 without decoding the supplied reproduction data and the multiplexer 47 multiplexes the supplied data and outputs the multiplexed data. Alternatively, each type of data may be independently output without use of the multiplexer 47.

In the disc recording and reproducing apparatus 10, when the user issues a data recording command with the operating portion 21, data supplied from the signal input and output portion 31 is supplied and recorded on the optical disc 1 through the data converting portion 19, the memory controller 17, the signal processing portion 16, and the pickup portion 13.

Next, the editing process in the disc recording and reproducing apparatus 10 will be described in brief. The optical disc 1 on which data has been recorded is loaded into the disc recording and reproducing apparatus 10. When an edit command is issued with the operating portion 21, a control signal corresponding to the edit command is supplied to the controlling portion 20. For example, a plurality of sets of IN points and OUT points for one or a plurality of clips and a reproduction order of sequences of AV data designated by these sets of IN points and OUT points are properly designated. As a result, it is expected that ranges of clips designated by the sets of the IN points and OUT points are successively reproduced in the designated order in real time.

Edit points may be designated in accordance with sub AV data reproduced from the optical disc 1. In other words, when the editing process is performed, the disc recording and reproducing apparatus 10 is controlled so that only sub AV data rather than main AV data is reproduced from the optical disc 1. The reproduced sub AV data is displayed on a monitor device (not shown). The user designates edit points of IN points and OUT points in accordance with a picture of sub AV data displayed on the monitor device. Information of the designated edit points is converted into for example address information of the corresponding main AV data. The address information is stored in the RAM of the controlling portion 20.

When the edit points and the reproduction order are designated, the controlling portion 20 creates an edit list corresponding to the designated edit points and reproduction order. The created edit list is stored in for example the RAM of the controlling portion 20.

The controlling portion 20 reads management information (for example, index file “INDEX.XML” and file “DISCINFO.XML”) of files that are edited from the optical disc 1 in accordance with the edit list and determines whether or not each of main AV data and sub AV data corresponding thereto can be independently nondestructively and successively reproduced in real time in accordance with the edit list.

For example, the controlling portion 20 checks record positions of clips on the optical disc 1 for each of main AV data and sub AV data and calculates seek times for IN points and OUT points are accessed in the case that each file placed in each clip directory is reproduced in the order designated by the edit list. The controlling portion 20 can determine whether or not a buffer underflow takes place for each of main AV data and sub AV data in accordance with the calculated seek times, the data rate at which each type of data is read, and the reproduction rate at which each type of data is reproduced (decoded).

The data rate at which data is read from the optical disc 1 and the reproduction rate of the data that is read from the optical disc 1 are known from the specifications of the apparatus. These values are pre-written to the ROM of the controlling portion 20. Alternatively, these values may be measured under the control of the controlling portion 20 when necessary.

When the determined result represents that a buffer underflow takes place in sub AV data that is reproduced, the controlling portion 20 causes a bridge clip for sub AV data to be created. For example, it is assumed that the IN₁ point, the OUT₁ point, the IN₂ point, and the OUT₂ point have been designated as edit points so that the regions designated thereby are reproduced in the order.

In this case, the region of main AV data designated by the IN₁ point and the OUT₁ point and then the region of main AV data designated by the IN₂ and the OUT₂ point are reproduced from the optical disc 1 in accordance with the edit list. The reproduced main AV data is supplied to the data converting portion 19 through the RF amplifier 14, the signal processing portion 16, a memory controller, and so forth and to the video data converting portion 45 of the data converting portion 19. The video data converting portion 45 decodes the supplied main AV data and supplies the decoded data to the sub AV data converting portion 48. The sub AV data converting portion 48 compression-encodes the supplied AV data in accordance with the compression-encoding system of sub AV data. In the example, the supplied AV data is encoded in accordance with a predetermined intra-frame compressing system and a predetermined inter-frame compressing system. As a result, a GOP composed of one I picture and nine P pictures is generated.

At that point, the sub AV data converting portion 48 connects each frame of main AV data in the range designated by the IN₁ point and the OUT₁ point and each frame of main AV data in the range designated by the IN₂ point and the OUT₂ point in accordance with the edit list and compression-encodes the connected frames, and creates a bridge clip as one successive file (see FIG. 12B). When there is a fraction in pictures of a GOP, the region from the fraction to the boundary of the GOP may be filled with stuffing bytes.

The created bridge clip is recorded on the optical disc 1. In addition, information of the created bridge clip is described in a play list. Moreover, the created bridge clip is reflected to an edit list. As a result, the edit list and the play list are rewritten on the optical disc 1.

It is preferred that a list of clips recorded on the optical disc 1 should be displayed on a monitor device or the like (not shown). For example, an index file “INDEX.XML” is read in accordance with a user's operation on the operating portion 21. As a result, information of all clips recorded on the optical disc 1 is obtained. Thereafter, with reference to each clip directory, thumbnail pictures are automatically created in accordance with sub AV data. A thumbnail picture is created by reading a frame at a predetermined position of sub AV data and reducing the frame in a predetermined size.

Thumbnail picture data of each clip is supplied to the memory controller 17 and then stored in the memory 18. Thumbnail picture data stored in the memory 18 is read by the memory controller 17 and supplied to the monitor device through the data converting portion 19 and the signal input and output portion 31. A list of thumbnail pictures is displayed on the monitor device. A thumbnail picture displayed on the display device can be controlled on the operating portion 21. A desired picture can be selected from thumbnail pictures by a predetermined operation on the operating portion 21. As a result, a clip corresponding to the selected thumbnail picture can be reproduced.

When the foregoing thumbnail picture is displayed on the monitor device, various types of information for example the bit rate of main video data, the encoding system, and so forth of the clip corresponding to the thumbnail picture that is displayed can be displayed along with the thumbnail picture. Such information can be displayed by reading time sequence meta data and non-time sequence meta data from each clip directory.

In the foregoing description, it is assumed that the editing method according to the present invention is executed by the disc recording and reproducing apparatus 10. However, it should be noted that a computer device that records video data to a disc shaped recording medium and reproduces video data therefrom can execute the editing method. In this case, the editing method according to the present invention is accomplished by supplying an editing program that causes a computer device to execute the editing method to the computer device through a recording medium or a network.

Alternatively, the disc recording and reproducing apparatus 10 may be a computer device that has the controlling portion 20. The controlling portion 20 has a CPU and a ROM that pre-stores the editing program. In this case, the controlling portion 20 controls the disc recording and reproducing apparatus 10 to perform the foregoing bridge clip creating process in accordance with the editing program pre-stored in the ROM.

In the foregoing description, the editing method according to the present invention is applied to video data. However, the present invention is not limited to such an example. In other words, the present invention is also suitable for other type of data such as audio data.

Moreover, in the foregoing description, the disc shaped recording medium according to the present invention is an optical disc that uses a blue-purple laser that irradiates laser light having a wavelength of 405 nm as a light source and that has a recording capacity of 23 GB. However, the present invention is not limited to such an example. For example, the present invention can be applied to other types of disc shaped recording mediums to which data can repeatedly written and from which data can be repeatedly erased such as a CD-RW disc, a DVD-RW disc and those to which data can be recorded such as a CD-R disc and a DVD-R disc.

As described above, according to the present invention, when AV data recorded on a disc shaped recording medium is edited, since a bridge clip of sub AV data is created from corresponding main AV data, the picture quality of a bridge clip for sub AV data can be kept almost constant against original sub AV data.

Thus, with only an edit result of sub AV data, AV data having a moderate picture quality can be obtained.

Although the present invention has been shown and described with respect to a best mode embodiment thereof, it should be understood by those skilled in the art that the foregoing and various other changes, omissions, and additions in the form and detail thereof may be made therein without departing from the spirit and scope of the present invention.

1. A picture processing apparatus, comprising:
reproducing means for reproducing first data recorded on a recording medium and/or second data encoded at a higher compression rate than the first data;
determining means for determining whether or not the second data can be reproduced by the reproducing means in real time in accordance with an edit list that represents a reproduction order of the first data and/or the second data; and
generating means for generating real time reproduction data from the first data when the determined result represents that the second data can not be reproduced in real time.

2. The picture processing apparatus as set forth in claim 1,
wherein the real time reproduction data generated by the generating means is recorded on the recording medium.

3. The picture processing apparatus as set forth in claim 1, further comprising:
means for creating a play list that is reproduced in accordance with the real time reproduction data.

4. The picture processing apparatus as set forth in claim 1,
wherein the second data is composed in the unit of a group composed of a reference frame and a predictive frame predicted and generated in accordance with the reference frame.

5. A picture processing method, comprising the steps of:
reproducing first data recorded on a recording medium and/or second data encoded at a higher compression rate than the first data;
determining whether or not the second data can be reproduced at the reproducing step in real time in accordance with an edit list that represents a reproduction order of the first data and/or the second data; and
generating real time reproduction data from the first data when the determined result represents that the second data can not be reproduced in real time.

6. A picture processing program causing a computer device to execute a picture processing method, comprising the steps of:
reproducing first data recorded on a recording medium and/or second data encoded at a higher compression rate than the first data;
determining whether or not the second data can be reproduced at the reproducing step in real time in accordance with an edit list that represents a reproduction order of the first data and/or the second data; and
generating real time reproduction data from the first data when the determined result represents that the second data can not be reproduced in real time.
